(19) United States
(12) Patent Application Publication
(10) Pub. No.: US 2007/0066743 A1
(43) Pub. Date: Mar. 22, 2007

(54) Use of a thermoplastic vulcanizate as an impact modifier in blends of polyester and polycarbonate

(75) Inventors: Marina Rogunova, Avon Lake, OH (US); Asis K. Banerjie, Avon Lake, OH (US); Ashok M. Adur, Avon Lake, OH (US)

Correspondence Address: POLYONE CORPORATION, 33587 WALKER ROAD, AVON LAKE, OH, 44012, US

(73) Assignee: POLYONE CORPORATION, Avon Lake, OH (US)

(21) Appl. No.: 10/596,663

(22) PCT Filed: Jan. 11, 2005
(86) PCT No.: PCT/US05/00792

§ 371 Date: Jun. 20, 2006

Related U.S. Application Data
(60) Provisional application No. 60/536,012, filed on Jan. 13, 2004.

(51) Int. Cl. C08K 9/04

(52) U.S. Cl. 524/445; 524/451; 524/494; 524/502

(57) ABSTRACT

A thermoplastic vulcanizate is disclosed for use in thermoplastic blends of polyester and polycarbonate. A minor amount of the thermoplastic vulcanizate improves the impact strength properties of the polyester/polycarbonate blend.

### CLAIM OF PRIORITY

This application claims priority from U.S. Provisional Patent Application Ser. No. 60/536,012 bearing Attorney Docket Number 12003019 and filed on Jan. 13, 2004.

### FIELD OF THE INVENTION

This invention relates the use of a thermoplastic vulcanizate as an impact modifier in blends of polyester and polycarbonate.

### BACKGROUND OF THE INVENTION

Blends of polycarbonate and polyester and their need for impact modification are well known. For example, European Patent Publication EP1207172A2 discloses an improved impact modifier for blends of polyester with other polymers, including polycarbonate, wherein the impact modifier itself is a blend of a core/shell additive and a linear copolymer of olefin, alkyl acrylate, and glycidyl methacrylate monomers.

### SUMMARY OF THE INVENTION

What is needed is better impact modification for blends of polycarbonate (PC) and polyester, especially polyethylene terephthalate (PET) and/or polybutylene terephthalate (PBT). There is a need to produce blends which have good impact properties, smooth surface finishes, weatherability, scratch resistance, solvent resistance, and a balance of flexural modulus, heat distortion temperature, and impact properties.

The present invention provides use of a thermoplastic vulcanizate (TPV) as a impact modifier that enhances impact properties throughout service temperatures (−40° C. to 98° C.) for polyester/polycarbonate blends, particularly PC-PET or PC-PBT blends without compromising heat distortion temperature or flexural modulus properties.

The new impact modifier can be used alone, or optionally in combination with one or both of the impact modifiers disclosed in EP1207172A2. The impact modifier is a thermoplastic vulcanizate, which is a blend of a polyolefin and a rubber. The rubber can be fully-crosslinked, partially cross-linked, or dynamically cross-linked during blending of the impact modifier in the thermoplastic polymer.

One aspect of the present invention is a thermoplastic polymer blend, comprising (a) a polyester; (b) a polycarbonate; and (c) a minor amount of a thermoplastic vulcanizate.

“Minor amount” means the amount of thermoplastic vulcanizate in the blend is less than the sum of the amounts of the polyester and the polycarbonate. Preferably, the thermoplastic vulcanizate remains as distinct domains within the thermoplastic polymer blend.

One feature of the blends of the present invention is good impact properties at service temperatures ranging from about −40° C. to 98° C. without compromising other physical properties otherwise present, e.g., flexural modulus, tensile strength, and heat distortion temperature.

An advantage of the blends of the present invention is that a single compound can be converted into parts that requires service temperatures ranging from about −40° C. to 98° C. In some applications, the parts produced from these blends can be exposed to high temperature at one section of the part and to low temperature at another section without failure. For example, in an exterior automotive application, the same part can function predictably notwithstanding its use in Alaska in the winter and Arizona in the summer. Moreover, a part designed to be adjacent a heat source can function even in a very cold environment, for example, a snow blower engine housing.

Another advantage of the blends of the present invention is that the blend can be pigmented according to design color choice of the manufacturer with an excellent surface finish.

Other features and advantages will be revealed in the discussion of the embodiments below.

### EMBODIMENTS OF THE INVENTION

Thermoplastic Polymers to be Impact Modified

The thermoplastic polymers can be a blend of polycarbonate (PC) and polyester (such as polyethylene terephthalate (PET), polypropylene terephthalate (PPT), polybutylene terephthalate (PBT), poly(ethylene-2,6-napthalate) (PEN), polypropylene napthalate (PPN), poly(1,4-cyclohexanedimethanol terephthalate) (PCT), polyethylene naphthalate dibenzoate (PENDB), and polybutylene naphthalate (PBN)).

Additionally, one can add to the blend any of a number of polymers of the polycondensate type including without limitation, and polyester-type of liquid crystalline polymers (LCP).

Of these possibilities, a blend of polycarbonate and a polyester is desirable with a blend of PC with either PET or PBT being preferred.

The amount of thermoplastic polymer in the blend can range from about 50 to about 95, and preferably from about 60 to about 90 weight percent of the blend.

The relative contribution of the polycarbonate to the blend ranges from about 15 to about 85 weight percent, and preferably from about 20 to about 70 weight percent of the blend.

The relative contribution of the polyester to the blend ranges from about 15 to about 85 weight percent, and preferably from about 20 to about 70 weight percent of the blend.

Thermoplastic Vulcanizate Impact Modifier

Any thermoplastic vulcanizate can be useful in the present invention to the extent that it exhibits compatibility with the polyester and polycarbonate polymers.

Non-limiting examples of commercially available thermoplastic vulcanizates include partially and fully vulcanized TPVs known to one skilled in the art, including Onflex™-V from PolyOne, Santoprene™ from ExxonMobil Chemicals, Sarlink™ from DSM, Nexprene™ and Respond™ from Solvay, and Forprene™ brand thermoplastic vulcanizates from SoFteR SpA.

Of the vulcanized portion of the thermoplastic vulcanizate, ethylene-propylene-diene (EPDM) is preferred because it has one of the lowest glass transition temperatures (T_{g}) available commercially and yet is reasonable in cost.

As stated above, the thermoplastic vulcanizate can be fully cross-linked at the time mixing into the blend or partially cross-linked, or uncross-linked but ready for dynamic vulcanization during melt blending of the polyester and polycarbonate resins.

As stated above, the thermoplastic vulcanizate is present in a minor amount. Desirably, the thermoplastic vulcanizate can be included in the blend of the present invention in an amount from about 3 to about 40, and preferably from about 5 to about 20 weight percent of the blend. Most preferably, the amount is about 7 to about 10 weight percent of the blend.

Optional Core/Shell Impact Modifier

The optional impact modifier is comprised of (A) a core/shell additive comprised of core based on alkyl acrylate, on a polyorganosiloxane rubber or a blend thereof and a shell based on poly(alkyl methacrylate), or on a styrene-acrylonitrile copolymer. Preferably the core/shell additive comprises from: (a) 70% to 90% by weight, of an elastomeric crosslinked core which is comprised of: 1) of 20% to 100% by weight, of a nucleus composed of a copolymer (I) of n-alkyl acrylate, the alkyl group of which has a carbon number ranging from 5 to 12, and preferably ranging from 5 to 8, or of a mixture of alkyl acrylates, the linear or branched alkyl group of which has a carbon number ranging from 2 to 12, or of a polyorganosiloxane rubber, of a polyfunctional crosslinking agent possessing unsaturated groups in its molecule, at least one of which is of CH2=C <vinyl type, and optionally of a polyfunctional grafting agent possessing unsaturated groups in its molecule, at least one of which is of CH2=CH—CH2—allyl type, the said nucleus containing a molar amount of crosslinking agent and optionally of grafting agent ranging from 0.05% to 5% and preferably an amount of between 0.5% and 1.5%; 2) of 80% to 0% by weight of a covering composed of a copolymer (II) of n-alkyl acrylate, the alkyl group of which has a carbon number ranging from 4 to 12, or of a mixture of alkyl acrylates as defined above in 1) and of a polyfunctional grafting agent possessing unsaturated groups in its molecule, at least one of which is of CH2=CH—CH2—allyl type, the said covering containing a molar amount of grafting agent ranging from 0.05% to 2.5%; (b) 30% to 10% by weight, of a shell grafted onto the said core composed of a polymer of an alkyl methacrylate, the alkyl group of which has a carbon number ranging from 1 to 4, or alternatively of a statistical copolymer of an <DP=2 alkyl methacrylate, the alkyl group of which has a carbon number ranging from 1 to 4, and of an alkyl acrylate, the alkyl group of which has a carbon number ranging from 1 to 8, containing a molar amount of alkyl acrylate ranging from 5% to 40%, or alternatively composed of a styrene-acrylonitrile copolymer having a preferred styrene:acrylonitrile molar ratio between 1:1 and 4:1, and particularly between 7:3 and 3:1, respectively; wherein optionally 0.1 to 50 weight percent of vinyl monomers have functional groups.

Such core/shell impact modifiers are commercially available such as the n-octyl acrylate rubber core/polymethylmethacrylate shell product commercially available as “D-400” from Atofina Chemicals, Inc. of Philadelphia, Pa.

Such core/shell impact modifier can be included in the blend of the present invention in an amount from about 0 to about 10, and preferably from about 0 to about 7. Most preferably, the amount is about 1 to about 5 percent by weight of the blend.

Optional Linear Terpolymer Impact Modifier

This optional impact modifier comprises a linear terpolymer of (a) ethylene, (b) a lower alkyl acrylate and (c) a monomer which contains a heterocycle containing one oxygen atom as the hetero-atom.

“Lower alkyl acrylate” means a C₁-C₈ and preferably a C₁-C₄ alkyl ester of (meth)acrylic acid. Of these possibilities, methyl acrylate is preferred.

Preferably the heterocyclic monomer contains an epoxy atom.

Relative amounts of monomer in the terpolymer range from 55-75 weight percent ethylene, 20-30 weight percent lower alkyl acrylate, and 5-15 weight percent heterocyclic monomer.

Such linear terpolymer impact modifiers are commercially available such as the ethylene-methyl acrylate-glycidyl methacrylate product commercially available as “Lotader AX 8900” from Atofina Chemicals, Inc. of Philadelphia, Pa.

Such linear terpolymer impact modifier can be included in the blend of the present invention in an amount from about 0 to about 10, and preferably from about 0 to about 7. Most preferably, the amount is about 1 to about 5 percent by weight of the blend.

Each of the three impact modifiers can be in powder, flake, or pellet form. They can be blended together into a concentrate or mixed with the thermoplastic polymers during melt processing in preparation for direct molding or pelletization for later molding.

Optional Additives

As with many thermoplastic compounds, it is optional and desirable to include other additives to improve processing or performance. Non-limiting examples of such optional additives include slip agents, antiblocking agents, antioxidants, ultraviolet light stabilizers, quenchers, dyes and pigments, plasticizers, mold release agents, lubricants, antistatic agents, fire retardants, and fillers such as glass fibers, talc, chalk, or clay. Of these fillers, the properties of nanoclay can add stiffness, toughness, and charring properties for flame retardancy.

Such optional additives can be included in the blend of the present invention in an amount from about 0 to about 40, and preferably from about 0.1 to about 30 weight percent. Most preferably, the amount is about −0.5 to about 10 weight percent of the blend.

Method of Processing Blends

The blend of the present invention can be prepared by any method which makes it possible to produce a thoroughly mixed blend containing the polycarbonate, the polyester, and the thermoplastic vulcanizate impact modifier along with any optional impact modifiers described above, and other optional additives, if any. It is possible, for example, to dry-mix the ingredients constituting the compound, then to extrude the resulting mixture and to reduce the extrudate to pellets.

As an example, extrusion can be carried out in a suitable extruder, such as a Werner-Pfleiderer co-rotating twin screw extruder. The extruder should be capable of screw speeds ranging from about 10 to about 2000 rpm, preferably from about 50 rpm to 1500 rpm. The temperature profile from the barrel number two to the die should range from about 170° C. to about 350° C., and preferably from about 220° C. to about 270° C. so as to extrude at the processing temperature of the components of the desired compound. The extruder can be fed separately with the ingredients of the blend or together.

The selected temperature range should be from about 200° C. to about 260° C. for a PC/PBT based blend or a PC/PET based blend. The extrudate can be pelletized or directed into a profile die. If pelletized, the pellets can then be converted to an article by injection molding, compression molding, blow molding or other techniques known to those skilled in the art.

Preferably, one can introduce the polycarbonate and the polyester in split feed streams in two different ports of the extruder (main throat and down stream locations) with the use of both atmospheric vents and vacuum vents as preferred by those skilled in the art. High specific energy input is desirable to reduce the size of the impact modifier particles and to encourage uniform dispersion in the thermoplastic polymers. One can use a temperature profile of between 200 and 260° C., depending on the number and type of optional additives also included in the extruded blend. It is optional to dry the components prior to compounding, depending on the performance properties of final product.

The thermoplastic vulcanizate can be added in its final form or produced in situ during the extrusion compounding of the blends of this invention. If dynamic vulcanization of the thermoplastic vulcanizate is to occur during melt blending, then the following additional items are required or recommended: The uncured PP-EPDM-oil blend is added along with a suitable crosslinking agent, which can include sulphur or its compounds, a peroxide with or without a co-agent, a phenolic resole resin with or without a catalyst activator like an acid or a Lewis acid or a proton donor, or other means known to one skilled in the art.

Usefulness of the Invention

Impact-modified thermoplastic polymer blends of the present invention are useful for transportation-related molded items (e.g., crash helmets and parts for vehicles such as bumpers and fenders); electrical equipment when flame retardants or reinforcing fillers are also added (e.g., plugs, connectors, boxes, and switches); and consumer appliance housings and containers (e.g., kitchen appliance housings and shells, and consumer electronics housings and cases).

Further embodiments of the invention are described in the following Examples.

### EXAMPLES

### Comparative Example A

A mixture of 27.98% of a polybutylene terephthalate (Crestin™ 610 from DuPont), 2.41% of Durastrength™ 400 (a core-shell acrylic-based impact modifier from Atofina), 4.82% of a compatibilizer (Lotader™ AX8900 from Atofina), 0.96% of an antioxidant (Ultranox™ 626 (from GE Specialty Chemicals, now from Crompton Corp.), 0.32% of an antioxidant (Irganox™ 1010 from Ciba Specialties), 0.21% of an antioxidant (Mark™ 135A from Crompton Corp.), 0.21% of a thioether stabilizer (Naugard™ 412S from Crompton Corp.) and 1.59% of a lubricant (AC540™ from Honeywell) was dry blended and fed into the main feed of a 44L/D 25 mm. twin screw extruder and another blend of 59.09% of a reprocessed polycarbonate and 2.41% of Durastrength™ 400 was fed in a side feeder downstream into the melt. For Example 1, the process temperatures were set at 402, 452, 452, 476, 450, 469, 431, and 424° F. (205° C.-233° C.-233° C.-247° C.-232° C.-243° C.-222° C.-218° C.) on the various zones on the extruder barrel, 453° F. (234° C.) at the die with a feed rate of 30 lb./hr. (13.6 kg/hr) at 900 rpm. This resulted in a die pressure of 169 psi (1.165 mPa) and a torque of 69%. A vacuum of 20 in. (50.8 cm) was used at the vent to deal with any possible volatiles. The strands from the strand die were fed through a water bath into a pelletizer and the products pelletized. The pellets were subsequently injection molded into the various required test specimens on a Nissei injection molding machine operating at 250° C. (T-melt).

### Example 1

A blend of 43.08% of a polybutylene terephthalate (PBT 610 from DuPont), 0.96% of Elvaloy PTW (an ethylene-n-butyl acrylate-gycidyl methacrylate compatibilizer from Du Pont), 1.48% of another compatibilizer (Interloy 1095 from Crompton Corp.), 7.18% of a partially crosslinked TPV, 0.95% of an antioxidant (Ultranox 626 (from GE Specialty Chemicals), 0.31% of an antioxidant (Irganox 1010 from Ciba Specialties), 0.21% of an antioxidant (Mark 135A from Crompton Corp.), 0.21% of a thioether stabilizer (412S from Crompton Corp.) and 1.58% of a lubricant (AC540 from Honeywell) were dry blended and fed into the main feed of a 44L/D 25 mm. twin screw extruder and another blend of 43.08% of a reprocessed polycarbonate and 0.96% of D-400 were fed in a side feeder downstream into the melt.

The partially crosslinked TPV had been made in two steps. In the first step a masterbatch was prepared in a Banbury with 3.225 lb. of an oil-extended EPDM (Buna EP G 3569 from Bayer), 0.417 lb. of a 0.5 MFR polypropylene homopolymer (Pro-fax PDC 1272 from Basell), 0.045 lb. of a 10-14 MFR polypropylene homopolymer, 0.910 lb. of a reactor TPO based on propylene and ethylene (Hifax CA10A from Basell), 1.445 lb. of a paraffinic oil (6001R from Chevron-Texaco), 0.730 lb. of a 12 MFR polypropylene (Pro-fax PH6331NW from Basell), 0.730 lb. of a talc (Cimpact 610 from Luzenac America), 0.161 lb. of zinc oxide (Kadox 915 from Zinc Corp.), 0.010 lb. of zinc stearate (from Witco Division of Crompton Corp.), 0.010 lb. of calcium stearate (from Crompton Corp.), 0.010 lb. of stearic acid (Emersol 132 from ChemCentral Corp.), 0.005 lb. of an antioxidant (Irganox 1010 from Ciba Specialties, 0.005 lb. of another antioxidant (Ultranox 626 from Crompton), 0.005 lb. of another antioxidant (Anox 18 from Great Lakes Chemicals), 0.005 lb. of a phosphite stabilizer (Irgafos 168 from Ciba Specialties) and 0.030 lb. of titanium dioxide (RCL-188 from Tiona). Microthene 709FA was used as a dusting agent to make sure that the masterbatch pellets did not agglomerate after the molten mix from the Banbury was conveyed to a rubber roll mill set at 280° F. (138° C.) and then the sheets from the roll mill were diced on a dicer into pellets. These masterbatch pellets were further compounded in a second step into a partially vulcanized TPV using the following formulation on a 25 mm. 44L/D twin screw extruder manufactured by Werner-Pfleiderer (now called Coperion). A pellet blend of 88.0% masterbatch from above, 7.0% of the same 12 MFR PP used above, and 0.1% of the same titanium dioxide used above were fed into the main hopper while 4.9% of a molten mixture, made from 36% of a phenolic resole resin (SP 1045 from Schenectady Chemicals) and 64% of the same paraffin oil used above, was injected hot at 150° C. into the twin screw down stream into the melt. Due to low residence times and insufficient co-catalyst, the TPV formed was partially crosslinked with a mostly EPDM-oil continuous phase. This partially crosslinked TPV was used as the impact modifier in the subsequent step to make the impact modified engineering plastic with polycarbonate-polyester alloy.

The process temperatures for this step were: 408, 452, 452, 477, 460, 472, 424, and 418° F. (205° C.-233° C.-233° C.-247° C.-237° C.-244° C.-218° C.-214° C.) on the various zones on the extruder barrel, 453° F. (234° C.) at the die with a feed rate of 30 lb./hr. (13.6 kg/hr) at 900 rpm. This resulted in a die pressure of 160 psi (1.103 mPa) and a torque of 35%. A vacuum of 18 in. (45.7 cm) was used at the vent to deal with any possible volatiles. The strands from the strand die were fed through a water bath into a pelletizer and the products pelletized. The pellets were subsequently injection molded into the various required test specimens on a Nissei injection molding machine operating at 250° C. (T-melt).

### Example 2

A blend of 43.03% of a polybutylene terephthalate (PBT 610 from DuPont), 0.96% of Elvaloy PTW (an ethylene-n-butyl acrylate-gycidyl methacrylate compatibilizer from Du Pont), 1.58% of another compatibilizer (Interloy 1095 from Crompton Corp.), 7.17% of a partially crosslinked TPV, 0.95% of an antioxidant (Ultranox 626 (from GE Specialty Chemicals), 0.32% of an antioxidant (Irganox 1010 from Ciba Specialties), 0.21% of an antioxidant (Mark 135A from Crompton Corp.), 0.21% of a thioether stabilizer (412S from Crompton Corp.) and 1.58% of a lubricant (AC540 from Honeywell) were dry blended and fed into the main feed of a 44L/D 25 mm. twin screw extruder and another blend of 43.03% of a reprocessed polycarbonate and 0.96% of D-400 were fed in a side feeder downstream into the melt.

The partially crosslinked TPV had been made in two steps. In the first step, a masterbatch was prepared in a Banbury with 46.08 parts of Buna EP G3569, 5.06 parts of Pro-fax PDC1272, 0.64% of Pro-fax PH6331NW, 12.88 parts of Hifax CA10A, 10.43 parts of Cimpact 610, 2.3 parts of zinc oxide, 0.14 parts of zinc Stearate, 0.14 parts of calcium stearate, 0.14 parts of stearic acid, 0.005 parts of Irganox 1010, 0.005 parts of Ultranox 626, 0.005 parts of Anox 18, 0.005 parts of Irgafos 168, 0.43 parts of titanium dioxide, and 20.63 parts of Hydrobrite 550 PO Oil, where all the ingredients used were from the same sources as those listed in Example 1. Microthene 709FA was used as a dusting agent to make sure that the masterbatch pellets did not agglomerate after the molten mix from the Banbury was conveyed to a rubber roll mill set at 280° F. (138° C.) and then the sheets from the roll mill were diced on a dicer into pellets. These masterbatch pellets were further compounded in a second step into a partially vulcanized TPV using the following formulation on a 25 mm. 44L/D twin screw extruder manufactured by Werner-Pfleiderer (now called Coperion).

A pellet blend of 88.0 parts masterbatch from above, 6.0 parts of the same 0.5 MFR PP used above, and 0.11 parts of the same titanium dioxide used above were fed into the main hopper along with 0.33 parts of Lowilite 26, a UV stabilizer from Great Lakes Chemicals, 0.33 parts of Lowilite 55, a phosphite stabilizer from Great Lakes Chemicals, 0.33 parts of Anox 20, an antioxidant from Great Lakes Chemicals, and 1.5 parts of SP 1055 Brominated Phenolic Resole Resin from Schenectady Chemicals. Hydrobrite 550 PO, a paraffin oil was injected into the twin screw down stream into the melt, at a ratio of 3.1:96.9 parts of the total mixture fed in the main hopper. Due to low residence times and insufficient co-catalyst, the TPV formed was partially crosslinked with a predominantly EPDM-oil continuous phase.

This partially crosslinked TPV was used as the impact modifier in the subsequent step to make the impact modified engineering plastic with polycarbonate-polyester alloy. The process temperatures for this step were: 408, 452, 452, 477, 460, 472, 424, and 418° F. (205° C.-233° C.-233° C.-247° C.-237° C.-244° C. -218° C.-214° C.) on the various zones on the extruder barrel, 453° F. (234° C.) at the die with a feed rate of 30 lb./hr. (13.6 kg/hr) at 900 rpm. This resulted in a die pressure of 160 psi (1.103 mPa) and a torque of 35%. A vacuum of 18 in. (45.7 cm) was used at the vent to deal with any possible volatiles. The strands from the strand die were fed through a water bath into a pelletizer and the products pelletized. The pellets were subsequently injection molded into the various required test specimens on a Nissei injection molding machine operating at 250° C. (T-melt). Table 1 summarizes the formulations for Examples 1-3 and order of addition.

TABLE 1

| Recipes in parts | | Comparative | | |
|---|---|---|---|---|
| Raw Materials | Supplier | Example A | Example 1 | Example 2 |

Fed at Throat:

| | | | | |
|---|---|---|---|---|
| PBT-610 | Du Pont | 27.98% | 43.08% | 43.03% |
| Durastrength 400 | Atofina | 2.41% | — | — |
| Lotader AX 8900 | Atofina | 4.82% | — | — |
| Elvaloy PTW | DuPont | — | 0.96% | 0.96% |
| Interloy 1095 | Crompton Corp. | — | 1.48% | 1.58% |
| TPV (partially crosslinked | PolyOne | | 7.18% | 7.17% |
| made from EPDM, PP and | | | | |
| oil) | | | | |
| Ultranox 626 | Crompton Corp | 0.96% | 0.95% | 0.95% |
| Irganox 1010 | Crompton Corp | 0.32% | 0.31% | 0.32% |
| Mark 135A | Crompton Corp | 0.21% | 0.21% | 0.21% |
| Naugard 412S | Crompton Corp | 0.21% | 0.21% | 0.21% |
| AC 540 | Honeywell | 1.59% | 1.58% | 1.58% |

Following items feed downstream:

| | | | | |
|---|---|---|---|---|
| Repro-PC | Commercial | 59.09% | 43.08% | 43.03% |
| | Recycling Co. | | | |
| D-400 | Atofina | 2.41% | 0.96% | 0.96% |

### Examples 3-5

The composition from Example 2 was further compounded with glass fiber and/or nanoclay using the formulations in Table 2:

TABLE 2

| Component | Example 3 | Example 4 | Example 5 |
|---|---|---|---|
| Pellets from Example 2 | 68% | 90% | 70% |
| Glass fiber | 32% | 0% | 20% |
| Nanoblend ™ 3100 nanoclay | 0% | 10% | 10% |
| concentrate (PolyOne) | | | |

The pellets from Example 2 were dried and then fed into the main feed hopper of a 25 mm 44 L/D extruder described in Comparative Example A with the same conditions described in Example 1. In the case of Examples 4 and 5, a masterbatch prepared from Nanoblend™ nanoclay concentrate, a nanoclay masterbatch in an ethylene-methyl acrylate copolymer, was fed into the main hopper along with the pellets prepared and described in Example 2. This resulted in a die pressure of 300, 150 and 310 psi, respectively, (2.068, 1.034, and 2.137 mPa, respectively) and a torque of 65%, 35% and 66%, respectively. A vacuum of about 20 in. (50.8 cm) was used at the vent to deal with any possible volatiles. The strands from the strand die were fed through a water bath into a pelletizer and the products pelletized. The pellets were subsequently injection molded into the various required test specimens on a Nissei injection molding machine operating at 250° C. (T-melt). The specimens from these three examples also showed excellent surface appearance and superior flexural modulus compared to those prepared from the Comparative Example A as well as those prepared in Examples 1 and 2.

Test Methods

Table 3 shows the test methods used in conjunction with the evaluation of the examples.

TABLE 3

| Test Name | Test Method |
|---|---|
| Heat Distortion | ASTM D648 (@ 66 psi and 264 psi) |
| Tensile Strength | ASTM D638 |
| Flexural Modulus | ASTM D790 |
| Notched Izod Impact Strength | ASTM D256 |
| % Elongation at Break | ASTM D638 Rigid |
| Surface Appearance | Visual Rating |

Results

Table 4 shows the experimental results from Comparative Examples A and Example 1.

TABLE 4

| | | Comparative | |
|---|---|---|---|
| Test | | Example A | Example 1 |
| Heat Distortion | Trial 1 | 92 | 100 |
| (° C.) with 66 psi Distortion | Trial 2 | 95 | 100 |
| | Average | 93.5 | 100 |
| Heat Distortion (° C.) with 264 | Trial 1 | 79 | 77 |
| psi Distortion | Trial 2 | 79 | 78 |
| | Average | 79 | 77.5 |

| | | |
|---|---|---|
| Stress at Yield (psi) | 7446 | 7764 |
| Stress at Break (psi) | 6340 | 5920 |
| Flexural Modulus (psi × 1000) | 325.4 | 339.4 |
| Average Impact (ft * lb/in) @ 23° C. | 15.35 | 12.48 |
| Average Impact (ft * lb/in) @ −20° C. | 3.58 | 2.24 |
| Average Impact (ft * lb/in) @ −40° C. | 2.92 | 2.06 |
| Elongation Strain at Break (%) | 110 | 34 |
| Surface Appearance | Moderately | Excellent |
| | Attractive | |

Table 3 shows that Example 1 outperforms Comparative Example A even though it had 15% less total impact modifier (8.1% vs. 9.6%). Example 1 had better flexural modulus and tensile strength at yield than Comparative Example A.

The invention is not limited to the above embodiments. The claims follow.

What is claimed is:

1. A thermoplastic polymer blend, comprising:
(a) a polyester,
(b) a polycarbonate, and
(c) a minor amount of a thermoplastic vulcanizate,
and further comprising one or both of
(d) a core/shell additive having an elastomeric core and
(e) a linear terpolymer of ethylene, alkyl(meth)acrylate, and a monomer which contains a heterocycle containing one oxygen atom as the hetero-atom.

2. The blend of claim 1, wherein the polyesters comprise polyethylene terephthalate (PET), polypropylene terephthalate (PPT), polybutylene terephthalate (PBT), poly(ethylene-2,6-napthalate) (PEN), polypropylene napthalate (PPN), poly(1,4-cyclohexanedimethanol terephthalate) (PCT), polyethylene naphthalate dibenzoate (PENDB), or polybutylene naphthalate (PBN).

3. The blend of claim 1, wherein the thermoplastic vulcanizate comprises partially or fully crosslinked EPDM as the elastomer phase.

4. The blend of claim 1, wherein the core/shell additive comprises a n-octyl acrylate rubber core and a polymethylmethacrylate shell.

5. The blend of claim 4,
wherein the amount of thermoplastic vulcanizate ranges from about 3 to about 40 weight percent of the blend;

6. The blend of claim 1,
wherein the amount of core/shell additive ranges from 0 to about 10 weight percent of the blend; and
wherein the amount of linear terpolymer ranges from 0 to about 10 weight percent of the blend.

7. The blend of claim 1, further comprising optional additives selected from the group consisting of slip agents, antiblocking agents, antioxidants, ultraviolet light stabilizers, quenchers, dyes and pigments, plasticizers, mold release agents, lubricants, antistatic agents, fire retardants, fillers, and combinations thereof.

8. The blend of claim 7, wherein the fillers comprise glass fibers, talc, chalk, or clay.

9. The blend of claim 8, wherein the clay is a nanoclay.

10. An article made from the blend of claim 1.
